(19) United States
(12) Patent Application Publication
(10) Pub. No.: US 2003/0186027 A1
(43) Pub. Date: Oct. 2, 2003

(54) Micro-passage element used for fluid analysis

(75) Inventors: Nobuyoshi Tajima, Tokyo (JP); Etsuo Shinohara, Tokyo (JP); Seiji Kondo, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS OPTICAL CO., LTD., Tokyo (JP)

(21) Appl. No.: 10/418,250

(22) Filed: Apr. 17, 2003

Related U.S. Application Data
(62) Division of application No. 09/053,426, filed on Apr. 1, 1998.

(30) Foreign Application Priority Data
Apr. 14, 1997 (JP) 9-095864

(51) Int. Cl. B32B 3/10

(52) U.S. Cl. 428/137; 428/172

(57) ABSTRACT

The micro fluid passage element of the present invention has the structure in which the first quartz glass substrate which is insulative and flat, and the second quarts glass substrate joining together while interposing the laminated film consisting of a polysilicon thin film, an alkali-ion containing glass layer such as borosilicate glass thin film, and a polysilicon thin film, the surfaces of the pair of quartz glass substrates, which are located on a joining side, being made to face each other, and the micro fluid passage element has a piecing hole serving as a fluid passage for instrumental analysis, formed along the laminated film and a direction of a surface of at least one of the pair of the quartz glass substrate, made at an arbitrary depth.

### BACKGROUND OF THE INVENTION

The present invention relates to a fluid passage used for an instrumental analysis, which is made by using a glass substrate.

Generally, a fluid passage used for an instrumental analysis is made of a micro-tube of glass, stainless steel, or the like.

Such a micro-tube is used in practice usually in a length of about 50 cm, in order to enhance the analytical performance; however when used, the micro-tube is coiled in circle, and therefore it is very difficult to miniaturize the tube.

Conventionally, there has been a report on a technique for miniaturizing a micro-tube with use of a semiconductor manufacturing method, in which a very fine micro-groove is made in a silicon substrate or the like. However, the conventional technique entails the following drawback. That is, when a silicon substrate is used for a capillary electrophoresis in which substances are separated by applying a high voltage thereto, a current leakage occurs in the silicon substrate, and therefore a high voltage cannot be applied.

In order to avoid such a drawback, there has been provided a technique of making a fluid passage as an instrumental analysis fluid passage in which no leakage of current occurs, by processing a fine micro-groove in a glass substrate of an insulating material.

For example, “Micromachining of Capillary Electrophoresis Injectors and Separators on Glass Chips and Evaluation of Flow at Capillary Intersections” (Anal. Chem. 1994, 66, page 177 to 184) discusses a fluid passage made by processing a groove in a borosilicate glass substrate and then welding the borosilicate glass substrate by heating.

The process of the groove is carried out in the following manner. That is, a metal deposition film is formed on a borosilicate glass substrate, and the metal film is patterned by the photolithography. Then, with use of the metal film as a mask, the borosilicate glass substrate is immersed into a solution in which hydrofluoric acid is mixed, so as to carry out etching for making a U-shape groove. Further, a flat borosilicate glass substrate is stacked on thus groove-processed borosilicate glass substrate, and the resultant is heated up to 700° C. for welding.

Apart from the above, “A New Fabrication Method of Borosilicate Glass Capillary Tubes with Lateral Inlets and Outlets” (Analytical Methods & Instrumentation, Special Issue μTAS '96 p 214) discusses a technique of forming a fluid passage by making a groove in a borosilicate glass substrate, and then joining thus processed borosilicate glass substrate and another flat borosilicate glass substrate together by an anodic joining method.

According to this technique, a groove is processed as follows. That is, a poly-Si thin film is grown on a borosilicate glass substrate by a low pressure chemical vapor deposition (LPCVD), and the polysilicon thin film is patterned with use of the photolithography. Then, with use of the polysilicon thin film as a mask, the borosilicate glass substrate is immersed into a solution in which hydrofluoric acid is mixed, so as to carry out etching for making a groove.

Then, in the anodic joining method, two borosilicate glass substrates are joined together with heat while applying a voltage between the polysilicon thin film on one borosilicate glass substrate, and the other polysilicon thin film.

In the general case of analyzing a fluid by separating substances from each other, using a fluid passage for instrumental analysis, a separated substance is detected by means of an optical manner.

However, in both of the above-described conventional techniques, borosilicate glass is used as a substrate for making a fluid passage for instrumental analysis, and therefore the passage absorbs the light of an ultraviolet wavelength region, thus making it impossible to perform an optical detection fir a short wavelength region.

### BRIEF SUMMARY OF THE INVENTION

The object of the present invention is to provide a fine micro fluid passage element having a fluid passage for instrumental analysis, which is capable of performing an optical detection over a range from ultraviolet to visible wavelength, and being easily miniaturized.

According to the present invention, there is provided a micro fluid passage element comprising: a laminated film formed by interposing an alkali-ion containing glass layer between a pair of silicon layers from both surfaces; and a pair of quartz glass substrates formed on both surfaces of the laminated film as to be joined together as an integral body in a manner that surfaces of the pair of quartz glass substrates, which are located on a joining side, face to each other, wherein the micro fluid passage element has a piecing hole serving as a fluid passage, formed along the laminated film and a direction of a surface of at least one of the pair of the quartz glass substrate, made at an arbitrary depth. There is further provided such a micro fluid passage element, wherein a light reflection layer or a light absorption layer having a plurality of light transmitting openings in the surfaces of the pair quartz glass substrates, which are located on the non-joining side, at positions which sandwich the fluid pass, is formed on the non-joining surface.

Additional object and advantages of the invention will be set forth in the description which follows, and in part will be obvious from the description, or may be learned by practice of the invention. The object and advantages of the invention may be realized and obtained by means of the instrumentalities and combinations particularly pointed out in the appended claims.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a schematic view of the structure of a micro-fluid passage element according to the first embodiment of the present invention;

FIG. 2A is a diagram illustrating a step of manufacturing the micro-fluid passage element according to the first embodiment;

FIG. 2B is a diagram illustrating another step of manufacturing the micro-fluid passage element according to the first embodiment;

FIG. 2C is a diagram illustrating still another step of manufacturing the micro-fluid passage element according to the first embodiment;

FIG. 2D is a diagram illustrating still another step of manufacturing the micro-fluid passage element according to the first embodiment;

FIG. 2E is a diagram illustrating still another step of manufacturing the micro-fluid passage element according to the first embodiment;

FIG. 2F is a diagram illustrating still another step of manufacturing the micro-fluid passage element according to the first embodiment;

FIG. 2G is a diagram illustrating still another step of manufacturing the micro-fluid passage element according to the first embodiment;

FIG. 2H is a diagram illustrating still another step of manufacturing the micro-fluid passage element according to the first embodiment;

FIG. 3A is a diagram illustrating still another step of manufacturing the micro-fluid passage element according to the first embodiment;

FIG. 3B is a diagram illustrating still another step of manufacturing the micro-fluid passage element according to the first embodiment;

FIG. 3C is a diagram illustrating still another step of manufacturing the micro-fluid passage element according to the first embodiment;

FIG. 3D is a diagram illustrating still another step of manufacturing the micro-fluid passage element according to the first embodiment;

FIG. 3E is a diagram illustrating still another step of manufacturing the micro-fluid passage element according to the first embodiment;

FIG. 3F is a diagram illustrating still another step of manufacturing the micro-fluid passage element according to the first embodiment;

FIG. 4 is a diagram showing a schematic view of the structure of a micro-fluid passage element according to the second embodiment of the present invention;

FIG. 5 is a diagram showing a schematic view of the structure of a micro-fluid passage element according to the third embodiment of the present invention;

FIG. 6 is a diagram showing a schematic view of the structure of a micro-fluid passage element according to the fourth embodiment of the present invention;

FIG. 7A is a diagram showing of the structure of the micro-fluid passage element according to the fourth embodiment, when viewed from above;

FIG. 7B is a diagram showing a cross sectional view of the structure, taken by line A-A of FIG. 7A;

FIG. 8A is a diagram illustrating a step of manufacturing the micro-fluid passage element according to the fourth embodiment;

FIG. 8B is a diagram illustrating another step of manufacturing the micro-fluid passage element according to the fourth embodiment;

FIG. 8C is a diagram illustrating a still another step of manufacturing the micro-fluid passage element according to the fourth embodiment;

FIG. 8D is a diagram illustrating a still another step of manufacturing the micro-fluid passage element according to the fourth embodiment;

FIG. 8E is a diagram illustrating a still another step of manufacturing the micro-fluid passage element according to the fourth embodiment;

FIG. 9 is a diagram showing a schematic view of the structure of a micro-fluid passage element according to the fifth embodiment of the present invention;

FIG. 10A is a diagram showing of the structure of the micro-fluid passage element shown in FIG. 9, when viewed from above;

FIG. 10B is a diagram showing a cross sectional view of the structure, taken by line A-A of FIG. 10A;

FIG. 11 is a diagram showing a schematic view of the structure of a micro-fluid passage element according to the six embodiment of the present invention;

FIG. 12 is a diagram showing a schematic view of the structure of a micro-fluid passage element according to the seventh embodiment of the present invention;

FIG. 13A is a diagram-showing of the structure of the micro-fluid passage element shown in FIG. 12, when viewed from above; and

FIG. 13B is a diagram showing a cross sectional view of the structure, taken by line A-A of FIG. 13A.

### DETAILED DESCRIPTION OF THE INVENTION

Embodiments of the present invention will now be described in detail with reference to accompanying drawings.

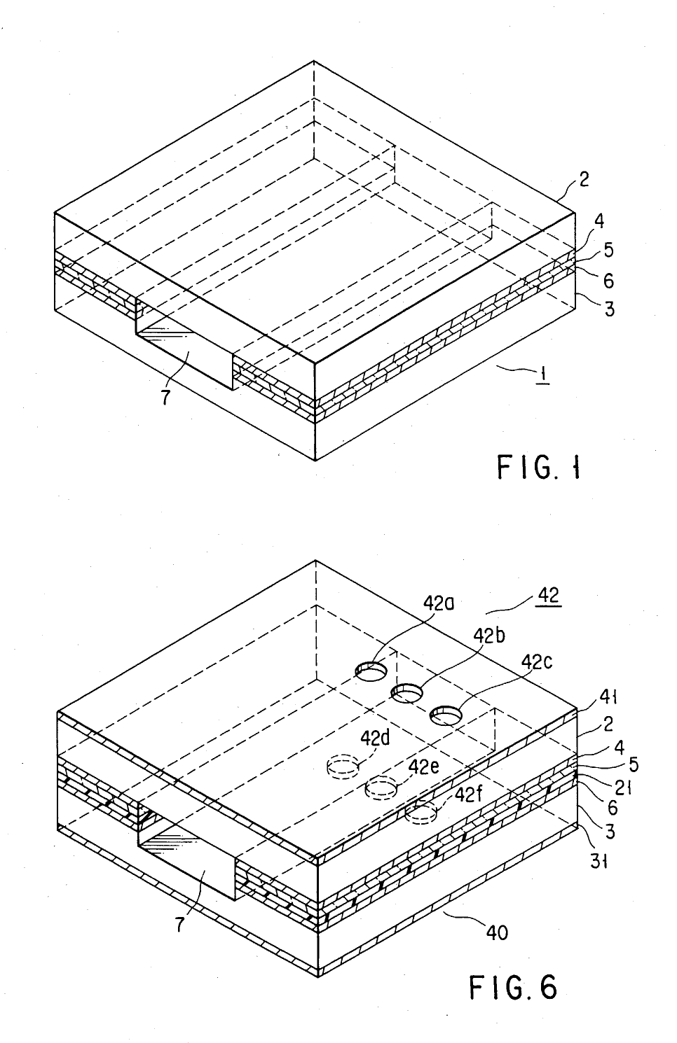

FIG. 1 is a diagram showing a schematic view of the structure of a micro fluid passage element according to the first embodiment of the present invention.

As shown, a micro-fluid passage element 1 has a structure in which a flat quartz glass substrate 2 and a flat quartz glass substrate 3 are joined together via a laminated layer consisting of a polysilicon thin film 4, an alkali ion-containing glass layer such as a borosilicate glass thin film 5 and a polysilicon thin film 6 and a piecing hole defined by these layers.

The piercing hole is defined by the cross sectional portions of the laminated layer (including the polysilicon thin film 4, the borosilicate glass thin film 5 and the polysilicon thin film 6), the lateral surface of the groove made in the quartz glass substrate 3 to have an arbitrary depth, the surface of the quartz glass substrate 2, and the bottom surface of the quartz glass substrate 3, arranged in parallel with each other. The piercing hole is used as a fluid passage for analyzing an instrument (to be called simply as fluid passage hereinafter).

It should be noted that in this embodiment, a groove is made in the quartz glass substrates; however it is possible that the groove is made in the quartz glass substrate 2 side, or the groove is made in both the quartz glass substrates.

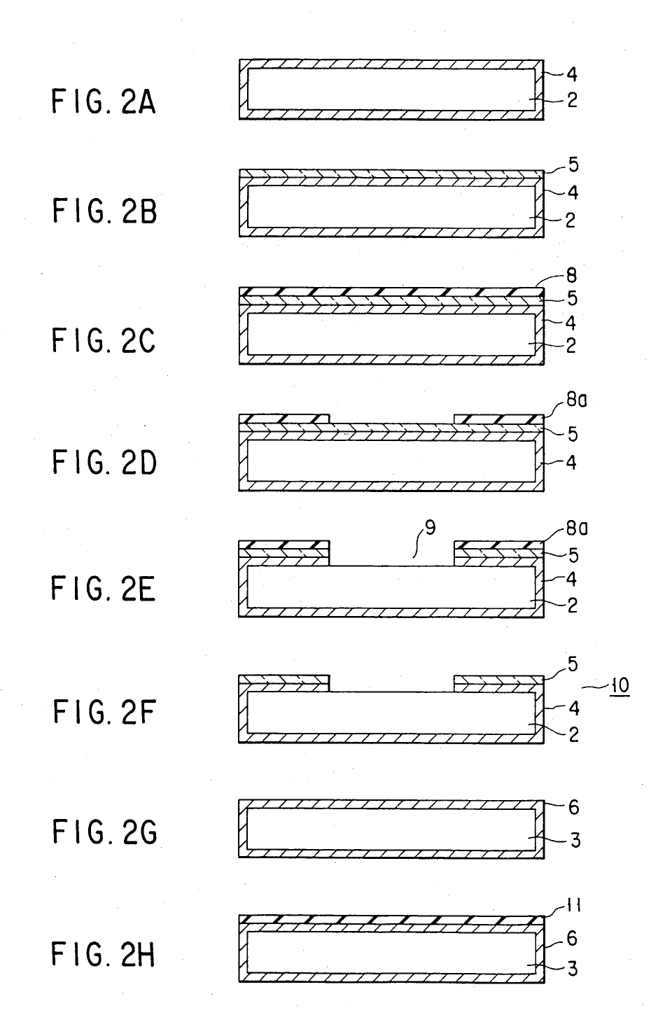

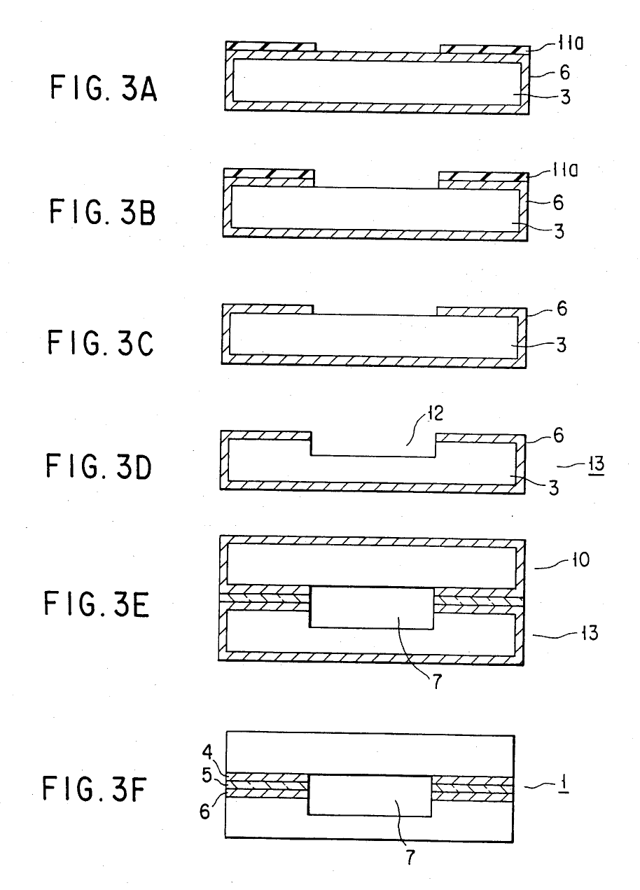

Next, the step of forming such a micro-fluid passage will now be described with reference to FIGS. 2A to 2H and FIGS. 3A to 3F.

First, as can be seen in FIG. 2A, a non-doped polysilicon thin film 4 is formed on the entire surface of the quartz glass substrate 2 by LPCVD. In this embodiment, the quartz glass substrate 2 should be formed by polishing a substrate from both surfaces to have a thickness of 1 mm or less, and the thickness of the polysilicon thin film 4 should be 1 μm or less.

Next, as can be seen in FIG. 2B, a borosilicate glass thin film 5 is formed on one surface of the polysilicon thin film 4 by sputtering. It is preferable that the thickness of the borosilicate glass thin film 5 should be 1 μm or less.

As can be seen in FIG. 2C, a positive-type photoresist is spin-coated on the surface of the borosilicate glass thin film 5 so as to form a resist film 8.

As can be seen in FIG. 2D, the resist film 8 is patterned by photolithographic technique so as to form a resist mask 8a. Further, as shown in FIG. 2E, the portion of the borosilicate glass thin film 5 which is exposed in the region other than that covered by the resist mask 8a is removed by anisotropic etching such as reactive ion etching (RIE), and then the underlying polysilicon thin film 4 is removed. After that, as shown in FIG. 2F, the resist mask 8a is removed by plasma asher, and thus a passage structuring substrate 10 having a groove 9 is formed.

Next, as can be seen in FIG. 2G, a non-doped polysilicon thin film 6 is formed on the entire surface of another quartz glass substrate 3 by LPCVD. It is preferable that the thickness of the borosilicate glass thin film should be 1 μm or less.

As can be seen in FIG. 2H, a positive-type photoresist is spin-coated on the surface of the polysilicon thin film 6 so as to form a resist thin film 11. After that, as can be seen in FIG. 3A, the resist then film 11 is patterned by photolithographic technique so as to form a resist mask 11a.

Further, as shown in FIG. 3B, the portion of the polysilicon thin film 6 which is exposed is removed by RIE, using the resist mask 11a as a mask, and then, as shown in FIG. 3C, the resist mask 11a is removed by plasma asher.

Next, as shown in FIG. 3D, a quartz glass substrate 3 is immersed in a solution in which hydrofluoric acid and ammonium fluoride are mixed together, and thus the exposed portion of the quartz glass substrate 3 is removed by wet-etching, while using the patterned polysilicon thin film 6 as a mask. In this manner, a fluid passage structure substrate 13 having a groove 12 is formed. It is preferable that the depth or width of the groove 12 should be 100 μm or less.

Further, as shown in FIG. 3E, the fluid passage structuring substrate 10 and the fluid passage structuring substrate 13 are placed one on another such that the groove 9 and the groove 12 coincides with each other, and they are joined together by an anodic joining method, thus forming an element substrate 14.

The anodic joining is carried out by heating the whole substrate while applying a voltage between the polysilicon thin film 4 and the polysilicon thin film 6. It is preferable that the heating temperature for this should be about 350 to 500° C., and the applied voltage should be 200 to 1000V.

Next, as shown in FIG. 3F, the polysilicon thin film on the surface of the element substrate 14 shown in FIG. 3E, obtained by the joining is removed by RIE or wet-etching, thus forming a micro-fluid passage element 1.

In this embodiment, a silicon layer consisting of a polysilicon thin film is used; however it may be consisting of an amorphous silicon thin film. Further, the silicon thin film should preferably be a non-doped silicon thin film. The silicon thin film can be made not only by LPCVD, but also by applying a semiconductor film forming technique such as plasma CVD, sputtering, ECR or evaporation.

In the meantime, the piercing hole 7 is formed to have a linear shape; however the shape is not limited to this, but it may be of a curved or wavy shape. Further, it is preferable that the depth or width of the piercing hole 7 should be 150 μm or less. In order to make a groove, wet- or dry-etching which is employed in the semiconductor technique, or a mechanical process, or the like can be used.

In this embodiment, a borosilicate glass thin film is used as an alkali-ion containing glass layer; however it may be a soda glass thin film or the like.

In the micro-fluid passage element 1 having the above-described structure, a piercing hole (fluid passage) is formed in a quartz glass substrate having an excellent transmitting property for light of a wavelength band from ultraviolet to visible. Therefore, it is becomes possible to carry out an optical detection in an ultraviolet to visible wavelength band.

The micro-fluid passage 1 is made mainly of glass, and the silicon thin film is a non-doped type, which has a thickness of 1 μm or less. Therefore, even if a high voltage is applied to the passage 1 as it is employed for capillary electrophoresis, the leakage of current which causes an influence to the electrophoresis, does not occur.

Further, the semiconductor process technique is employed in this embodiment, a very fine piecing hole passage can be easily made, and therefore the size of the micro fluid passage element can be reduced.

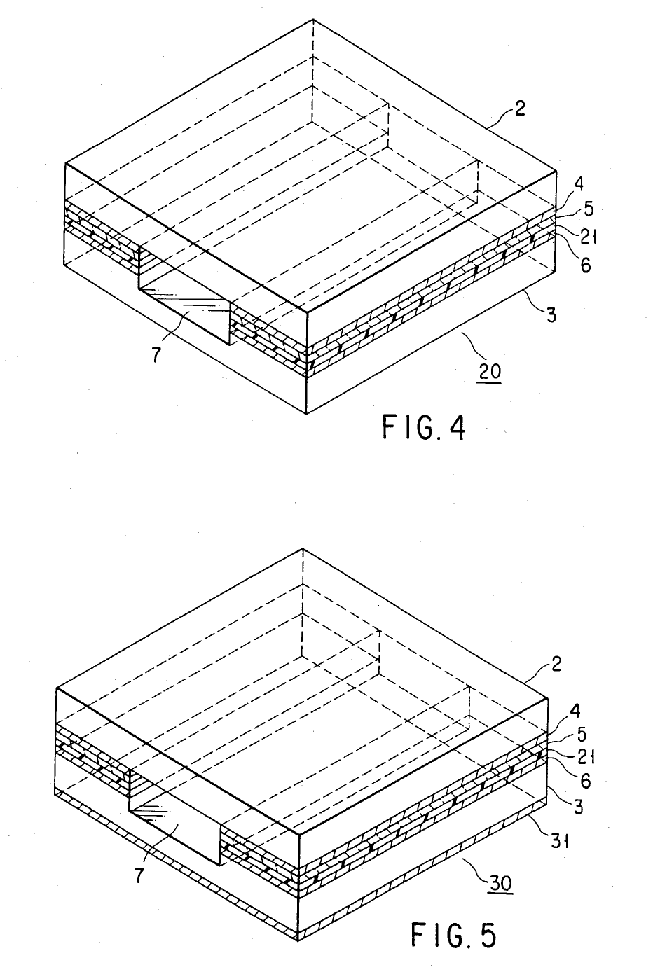

Next, a micro fluid passage element according to the second embodiment, will now be described in detail with reference to FIG. 4, which illustrates a schematic view of the structure of the element. In this figure, the structural members similar to those shown in FIG. 1 are designated by the same reference numerals.

In the micro-fluid passage element 20, a flat quartz glass substrate 2 and a flat quartz glass substrate 3 are joined together while interposing a laminated layer consisting of a polysilicon thin film 4, an alkali ion-containing glass layer (for example, borosilicate glass thin film) 5, a silicon oxide film (SiO₂) 21, a polysilicon thin film 6 and a piercing hole 7.

The piercing hole 7 functions as a fluid passage, and is a space made by cutting the laminated film (including the polysilicon thin film 4, the borosilicate glass thin film 5, the silicon oxide film (SiO₂) 21 and the polysilicon thin film 6), and defined by the surface of the quartz glass substrate 2 and the bottom surface of the groove made in the quartz glass substrate 3.

The micro fluid passage element 20 is formed by adding a step of forming a silicon oxide film 21 on the surface of the borosilicate glass thin film 5 by sputtering, between the steps shown in FIGS. 2B and 2C. It is preferable that the thickness of the silicon oxide film 21 should be 500 μm or less.

In the micro-fluid passage element 20, a silicon oxide film 21 serving as an insulating member is interposed between the borosilicate glass thin film 5 and the polysilicon thin film 6. With this structure, a further advantage can be obtained in addition to the effect of the micro-fluid passage element 1 prepared in the first embodiment. That is, current leakage caused by dielectric breakdown during anodic joining can be obtained. Therefore, the joining can be easily carried out. At the same time, it becomes easy to apply a high voltage between the polysilicon thin film 4 and the polysilicon thin film 6, and therefore the films can be easily joined even if the borosilicate glass thin film 5 is made thin.

Next, FIG. 5 shows a schematic view of the structure of a micro-fluid passage element according to the third embodiment.

A micro-fluid passage element 30 of this embodiment is an alternative version of the second embodiment, and in this embodiment, a polysilicon thin film 31 is formed on one surface of the micro-fluid passage element 20 of the second embodiment. Such a micro micro-fluid passage element 30 can be prepared by removing the polysilicon thin film 4 or polysilicon thin film 6 on one surface of the element 30, whereas leaving the polysilicon thin film on the other surface thereof, in the above-described FIG. 3E. FIG. 5 illustrates an example in which a film deposited during the formation of the polysilicon thin film 6 is left as a polysilicon thin film 31.

The micro-fluid passage element 30 having the above-described structure, in which the polysilicon thin film 31 is formed on one surface thereof, naturally entails the same operation and effect as those of the micro-fluid passage elements 1 and 20. Besides this, in the element 30, a light emitting element and a light receiving element are provided on the quartz glass substrate 2 on the upper side of the micro-fluid passage element, such that detection light is made incident from the quartz glass substrate 2, and the reflection light is detected. With this structure, the reflectance of light is improved during the analysis, thus enhancing the detection sensitivity.

It should be noted that in this embodiment, for example, the polysilicon thin film 31 which serves as a light reflection film, may be made of some other material than that used in this embodiment, or a metal thin film such as of aluminum may be provided in place of the polysilicon thin film 6.

FIG. 6 shows a schematic view of the structure of a micro-fluid passage element according to the fourth embodiment.

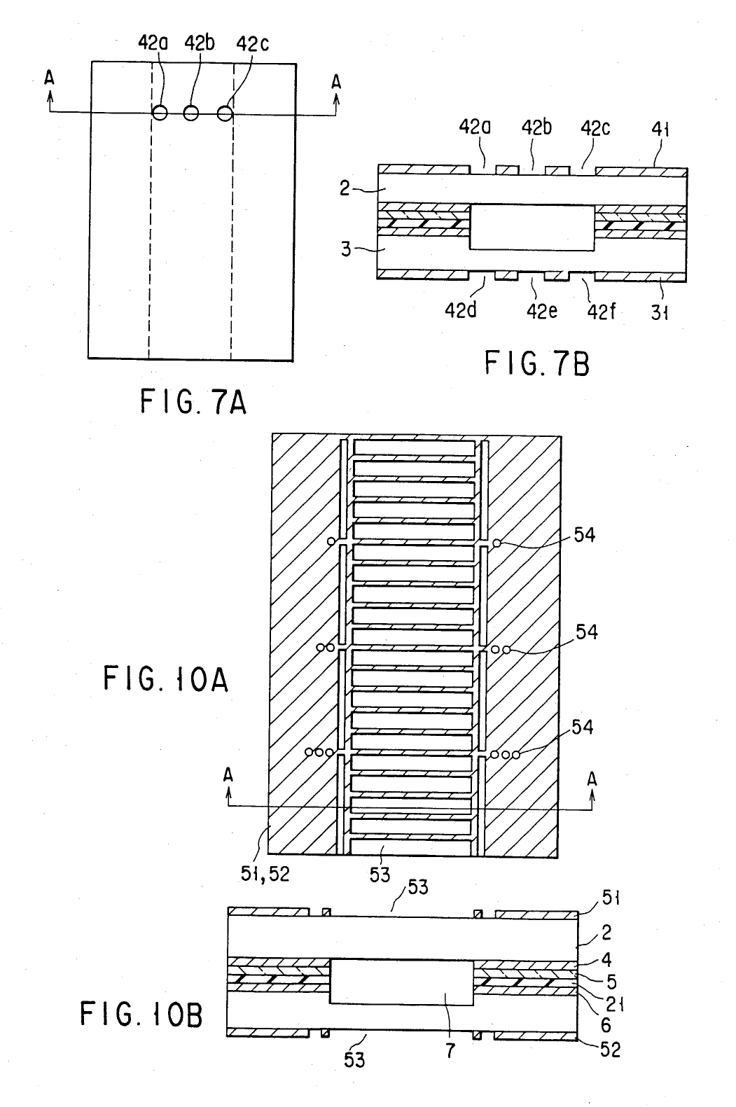

Further, FIG. 7A shows an upper surface of a micro-fluid passage element 40 of this embodiment, and FIG. 7B shows a cross section taken along the line A-A in FIG. 7A. It should be noted that the lower surface of the micro-fluid passage element 40 has the same shape as that of the upper surface shown in FIG. 6. The structural elements of this embodiment, which are similar to those shown in FIG. 5, are designated by the same reference numerals.

A micro-fluid passage element 40 has a structure in which a polysilicon thin film 31 and a polysilicon thin film 41 are formed on the respective surfaces of the before-described micro-fluid passage element 20, and a plurality of windows 42 are formed in the direction normal to the direction of the fluid passage 7, in sections of the polysilicon thin films 31 and 41, which interpose the fluid passage 7 therebetween, such that positions of the windows face to each other.

For example, windows 42a to 42f shown in FIG. 7B function as observation windows for receiving light from one surface, and detecting transmitted light from the other surface, and therefore it becomes possible to detect a substance which passes through a particular site of the fluid passage without especially collecting the detection light during an optical analysis. In particular, when these windows are reduced to a mico-size, it becomes possible to analyze a micro-area.

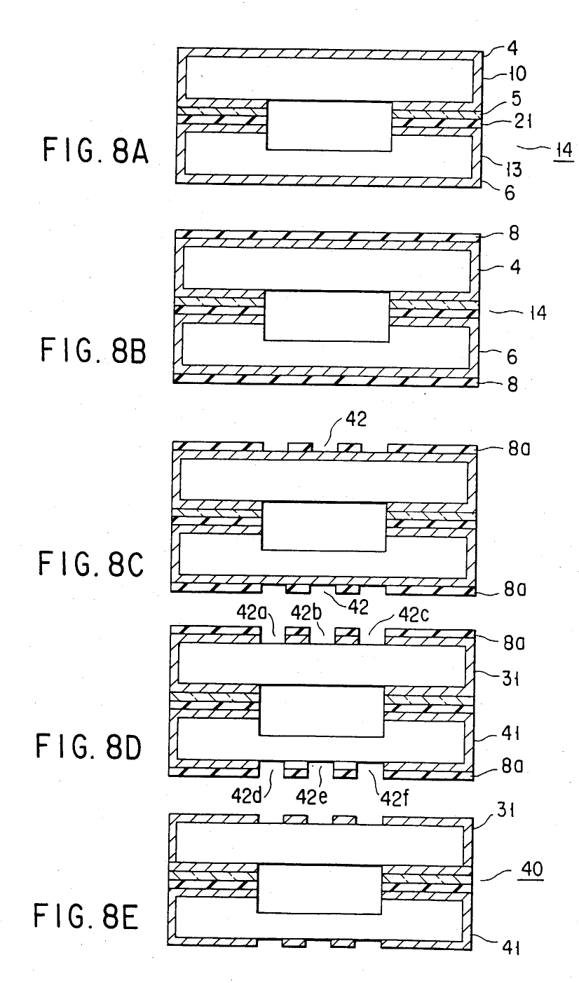

Next, the preparation of the micro-fluid passage element 40 will now be described with reference to the steps illustrated in FIGS. 8A to 8E.

As can be seen in FIG. 8A, the structure of this embodiment is formed by the manufacturing process for the second embodiment shown in FIG. 4, and the embodiment is an element substrate obtained by joining the fluid passage structuring substrate 10 and the fluid passage structuring substrate 13 together by the anodic joining method, while interposing the silicon oxide film 21 therebetween.

Then, as can be seen in FIG. 8B, photoresists are formed on the surfaces of the polysilicon thin films 4 and 6 which cover the respective surfaces of the element substrate formed by the joining as shown in FIG. 8A, by spin-coating, and thus resist thin films 8 are formed.

After that, as can be seen in FIG. 8C, each resist thin film 8 is patterned to have shapes of windows 42 as shown in FIG. 6, using the photolithographic technique, and thus a resist mask 8a is formed. Then, as shown in FIG. 8D, an RIE is carried out with use of the resist mask 8a as a mask, so as to remove the exposed sections of the polysilicon thin films 4 and 6, thus forming the polysilicon thin films 4 and 6 having the windows 42.

Further, as can be seen in FIG. 8E, the resist mask 8a is removed by the plasma asher, and thus a micro-fluid passage element 40 having three windows 42 on both surfaces thereof is formed. Although the figures show that the polysilicon thin films on both ends of the element are connected to the polysilicon thin film of the substrate joining surfaces, the polysilicon thin films 31 on both sides may be separated at the lateral surfaces, from the polysilicon thin films 4 and 6 on the joining surfaces, as can be seen in FIG. 7B. In addition to the operation and effect of the micro fluid passage element 1 and 20, the micro fluid passage element 40 of this embodiment has the windows 42 in both surfaces of the passage element, thus making it capable of detecting a substance passing through a particular site of the fluid pass.

It should be noted that the structural elements of this embodiment can be reformed or revised into various versions. For example, it is possible that the polysilicon thin films 31 and 41 can be replaced with some other films having a low light transmitting rate, and a metal thin film such as of aluminum, formed by, for example, sputtering, deposition or plating, can be used.

Further, although the windows 42 are provided in both surfaces of the element, they may be provided merely either one of the surfaces in the case where the reflection of light is utilized for the optical detection.

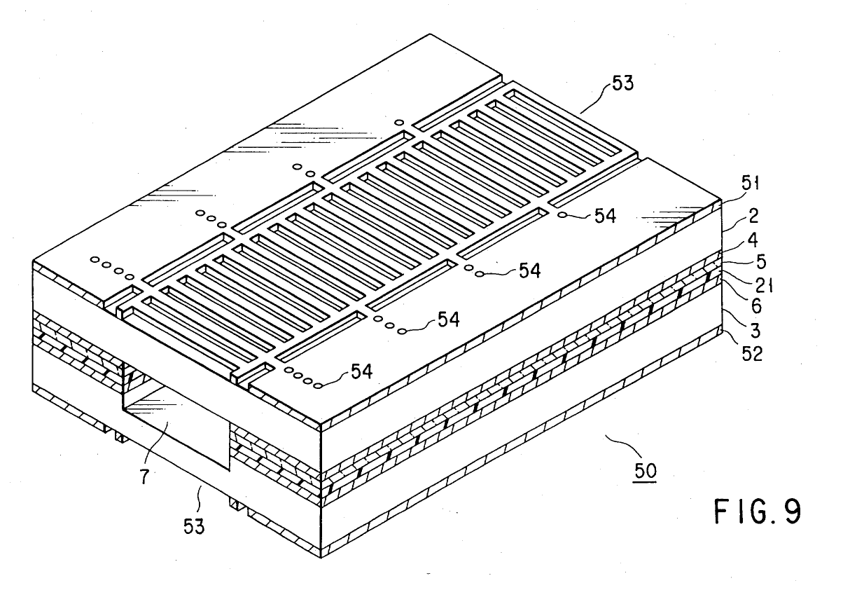

FIG. 9 shows a schematic view of the structure of a micro fluid passage element having an electrophoresis observation window, according to the fifth embodiment.

FIG. 10A shows the upper surface of such a micro fluid passage element, and FIG. 10 shows a cross section taken along the line A-A in FIG. 10A. It should be noted that the lower surface of the micro-fluid passage element has the same shape as that of the upper surface.

The micro fluid passage element 50 has a structure in which polysilicon thin films 51 and 52 are formed on the respective surfaces of the micro fluid passage element 20 of the second embodiment, and a plurality of windows 42 each having a rectangular shape elongated in the direction normal to the fluid passage 7, are formed in a ladder-like manner with a certain interval between adjacent windows along the direction of the fluid passage 7, in the polysilicon thin films 31 and 41, which interpose the fluid passage 7 therebetween, to be symmetrical to each other. Further, scales 54 which sectionalize these windows 53 by a certain number, are provided.

The micro fluid passage element 50 can be prepared the same forming steps as those for the micro fluid passage element 40, shown in FIGS. 8A to BE, except that the patterning shape of the resist mask formed on both surfaces of the element substrate is changed as described in this embodiment.

In addition to the operation and effect of the micro fluid passage element 1 and 20, the micro fluid passage element 50 of this embodiment has the windows 53 and scales 54 arranged with a certain interval therebetween, in both surfaces of the passage element, and therefore these windows and scales serve as a scale for the observation of the electrophoretic state, thus making it capable of easily tracing the electrophoretic state of an object to be analyzed.

It should be noted that the structural elements of this embodiment are not limited to the types discussed, but can be reformed or revised into various versions as long as the essence remains within the scope of the invention. For example, it is possible that the polysilicon thin films 51 and 52 can be replaced with some other films having a low light transmitting rate, and a metal thin film such as of aluminum, formed by, for example, sputtering, deposition or plating, can be used.

Further, although the windows 53 are provided in both surfaces of the element, they may be provided merely either one of the surfaces in the case where the reflection of light is utilized for the optical detection.

Next, the sixth embodiment of the present invention, a micro fluid passage element having an extended optical path, will now be described with reference to FIG. 11.

FIG. 11 is a cross sectional view showing a schematic view of the structure of this embodiment. The basis structure of the micro fluid passage element 60 is substantially the same as that of the micro fluid passage element 40 of the fourth embodiment, shown in FIGS. 6 and FIGS. 7A and 7B, expect that a plurality of recesses are made in the inner side of the quartz glass substrate 2 in this embodiment. It should be noted that the upper surface side (the polysilicon thin film 41) and the lower surface (the polysilicon thin film 31) of the micro fluid passage element 60 each have three windows 42a to 42c (the upper surface side) and 42d to 42f (the lower surface side) on the respective sides as in the fourth embodiment.

In the micro fluid passage element 60, a plurality of recesses 61a, 61b and 61c are made in the inner side of one of the quartz glass substrates which constitute the fluid passage 7 thereof. These recesses 61a, 61b and 61c are arranged in the inner side to the windows 42. In this embodiment, the number of the recesses is three; however the number is not limited to this.

In addition to the operation and effect of the micro fluid passage element 1 and 20, the micro fluid passage element 60 of this embodiment has a plurality of recesses formed in the inner side of the windows 42 for the optical detection of the fluid passage 7, and therefore the optical path of the detection region is elongated, thus making it possible to enhance the detection sensitivity.

It should be noted that the structural elements of this embodiment can be reformed or revised into various versions. For example, although the recesses 61a, 61b and 61c are provided in the inner side of one of the quartz glass substrates which constitute the fluid passage in this embodiment, the recesses may be formed in the inner side of both the quartz glass substrates. Further, it is possible that the polysilicon thin films 31 and 41 having windows 42 made in both surfaces of the element substrate, can be both omitted.

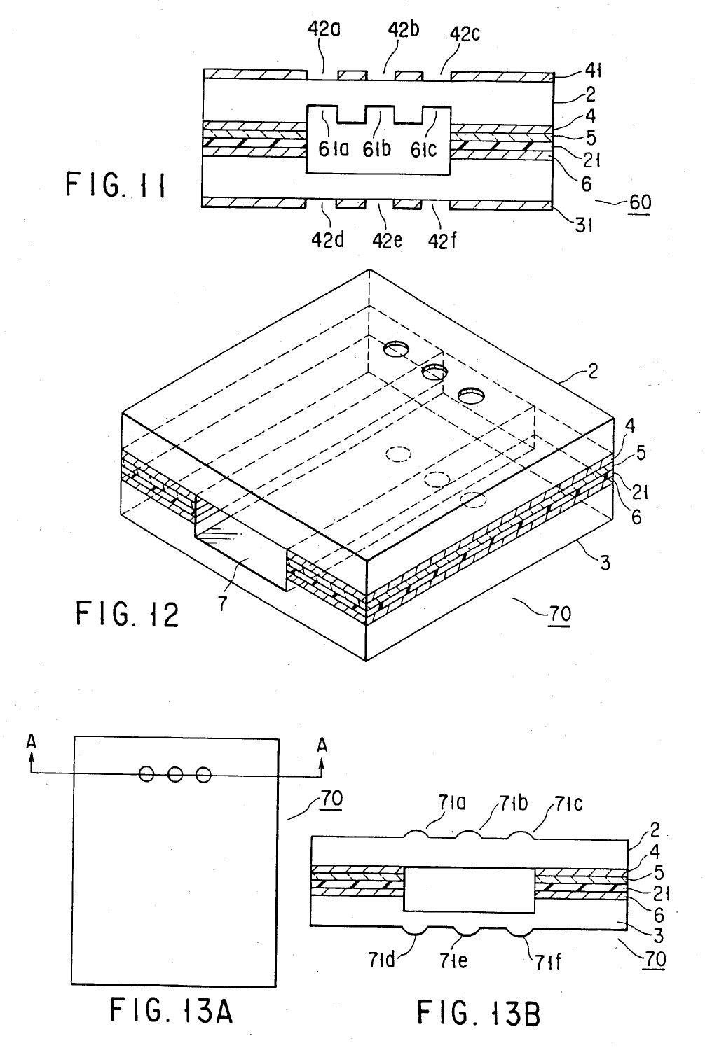

Next, the schematic structure of a micro fluid passage element having lenses, according to the seventh embodiment will now be described. FIG. 12 shows a schematic view of the structure of a micro fluid passage element having lenses, of this embodiment. FIG. 13A shows the upper surface of the micro fluid passage element, and FIG. 13B shows a cross section taken along the line A-A in FIG. 10A. It should be noted that the lower surface of the micro-fluid passage element has the same shape as that of the upper surface.

The micro fluid passage element 70 has a structure in which a plurality of convex lens-shaped projecting portions 71a to 71f are formed on the quartz glass substrates 2 and 3 which constitute the passage element, in the section above the fluid passage 70, to be arranged in the direction normal to the direction of the fluid passage 7.

In addition to the operation and effect of the micro fluid passage element 1 and 20, the micro fluid passage element 70 of this embodiment has a plurality of convex lens-shaped projecting portions 71a and 71f on both surfaces of the element substrate, with light being made incident from the projecting portion on one side, and transmitted light being detected from the projecting portions on the other side. With this structure, the incident light can be converged and thus the detection sensitivity can be improved. It should be noted that although six convex lens-shaped projecting portions are formed in this embodiment, the shape and number thereof are not limited to those of this embodiment, but can be varied as long as they have a similar function to that of this embodiment in a certain range.

As described above, according to the present invention, there is provided a micro fluid passage element having a fluid passage for instrumental analysis, capable of performing an optical detection in a wavelength region from ultraviolet to visible light, and being easily reduced in size.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalent.

1. A micro fluid passage element comprising:
a laminated film formed by interposing an alkali-ion containing glass layer between a pair of silicon layers from both surfaces; and
a pair of quartz glass substrates adhered on both surfaces of the laminated film as to be joined together as an integral body in a manner that surfaces of the pair of quartz glass substrates, which are located on a joining side, face to each other,
wherein the micro fluid passage element has a piercing hole as a fluid passage, said piercing hole being defined by the surfaces of the pair of quarts glass substrates, which are located on the joining side and the cross sections of the laminated film, as they face respectively each other, as a groove is made in the surface of at least one of the pair of quarts glass substrates to an arbitrary depth.

2. A micro fluid passage element comprising:
a laminated film formed by interposing a silicon oxide film and an alkali-ion containing glass layer laminated, between a pair of silicon layers from both surfaces; and
a pair of quartz glass substrates adhered on both surfaces of the laminated film as to be joined together as an integral body in a manner that surfaces of the pair of quartz glass substrates, which are located on a joining side, face to each other,
wherein the micro fluid passage element has a piercing hole as a fluid passage, said piercing hole being defined by the surfaces of the pair of quarts glass substrates, which are located on the joining side and the cross sections of the laminated film, as they face respectively each other, as a groove is made in the surface of at least one of the pair of quarts glass substrates to an arbitrary depth.

3. The micro fluid passage element according to claim 2, wherein a reflection film is formed on at least one of the surfaces of the pair of quartz glass substrates, which are located on a non-joining side.

4. The micro fluid passage element according to claim 3, wherein a reflection film is made of one of a polysilicon thin film and a metal thin film.

5. The micro fluid passage element according to claim 3, wherein one of a light reflection layer or a light absorption layer having a plurality of light transmitting openings in the surfaces of the pair quartz glass substrates, which are located on the non-joining side, at positions which sandwich the fluid pass, is formed on the non-joining surface.

6. The micro fluid passage element according to claim 5, wherein a scale is marked close to the light transmitting openings of the light reflection layer or the light absorption layer formed on the surfaces of the pair quartz glass substrates, which are located on the non-joining side, along a direction in which a fluid flows in the fluid passage.

7. The micro fluid passage element according to claim 5, wherein a recessed portion is provided in the openings made in the light reflection layer or the light absorption layer, in an inner side of the fluid passage of the quartz glass substrates.

8. The micro fluid passage element according to claim 2, wherein a convex shaped projection is provided on at least one of the surfaces of the quartz glass substrates, which are located on the non-joining side.

9. The micro fluid passage element according to claim 2, wherein a film having a low light transmitting rate is formed on the surfaces of the quartz glass substrates, which are located on the non-joining side, and at least one light transmitting window is formed at positions sandwiching the fluid passage.

10. The micro fluid passage element according to claims 1 and 2, wherein the silicon layer is made of polysilicon.

11. The micro fluid passage element according to claim 1, wherein a thickness of each of the quartz glass substrate is 1 mm or less, and both sides thereof is polished to be smooth, a thickness of the silicon thin film is 1 μm or less, and a thickness of the borosilicate glass thin film is 1 μm or less.

12. The micro fluid passage element according to claim 2, wherein a thickness of each of the quartz glass substrate is 1 mm or less, and both sides thereof is polished to be smooth, a thickness of the silicon thin film is 1 μm or less, a thickness of the borosilicate glass thin film is 1 μm or less, and a thickness of the silicon oxide film is 500 μm or less.

13. The micro fluid passage element according to claims 2 and 2, wherein a depth or width of the piercing hole is 150 μm.
